(19) United States
(12) Patent Application Publication
(10) Pub. No.: US 2026/0181444 A1
(43) Pub. Date: Jun. 25, 2026

(54) IMPROVING SCELL ACTIVATION THROUGH CELL CONDITION AND TCI ENHANCEMENTS

(71) Applicant: Apple Inc., Cupertino, CA (US)

(72) Inventors: Jie Cui, San Jose, CA (US); Xiang Chen, Campbell, CA (US); Rolando E. Bettancourt Ortega, Munich (DE); Yang Tang, San Jose, CA (US); Qiming Li, Beijing (CN); Dawei Zhang, Saratoga, CA (US); Manasa Raghavan, Sunnyvale, CA (US); Yuexia Song, Beijing (CN); Haitong Sun, Saratoga, CA (US); Hong He, San Jose, CA (US)

(21) Appl. No.: 19/125,452

(22) PCT Filed: Nov. 4, 2022
(86) PCT No.: PCT/CN2022/129976

§ 371 Date: Apr. 29, 2025

(51) Int. Cl. H04W 24/10; H04W 24/08

(52) U.S. Cl. CPC H04W 24/10; H04W 24/08

(57) ABSTRACT

Disclosed are methods, systems, and computer-readable medium to perform operations including: receiving, from a base station, an indication to activate a secondary cell (SCell); determining whether the SCell comprises a semi-unknown SCell with respect to the UE; and performing an SCell activation procedure based at least in part on the determination of whether the SCell comprises a semi-unknown SCell with respect to the UE.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

The present disclosure describes techniques for improving secondary cell (SCell) activation through cell condition and transmission configuration indication (TCI) enhancements. In accordance with an aspect of the present disclosure, a new condition of semi-unknown (or semi-known) for a target frequency range 2 (FR2) SCell is defined. In some implementations, the semi-unknown condition can be determined based on an indication from a user equipment (UE), such as an indication of a measurement status of the SCell or a report of a previously performed L3 measurement, among others. Alternatively, or in addition, the semi-unknown condition can be defined based on a time interval between RRC configuration of the SCell to the UE and the MAC CE command activating the SCell at the UE. By defining the semi-unknown at both the UE and network, the amount of time needed for SCell activation can be reduced. For example, on the UE side, the UE can skip or omit one or more measurement operations (e.g., L3 measurement and/or beam measurement, among others) when the SCell is semi-unknown, thereby reducing the SCell activation delay relative to activation of an unknown SCell. Similar reductions are achieved on the network side, as the network can perform earlier scheduling and/or directly activate TCI for the UE when the SCell is semi-unknown.

The present disclosure also describes techniques for default TCI determination with backwards compatibility. In this manner, the uncertainty time for TCI activation can be saved without creating conflicts in legacy systems.

In accordance with one aspect of the present disclosure, a method to be performed by a UE includes receiving, from a base station, an indication to activate a SCell, determining, by the UE, whether the SCell is a semi-unknown SCell to the UE, and performing an SCell activation procedure based at least in part on the determination of whether the SCell is a semi-unknown SCell to the UE.

In general, in an aspect, a method to be performed by a user equipment (UE) includes: receiving, from a base station, an indication to activate a secondary cell (SCell); determining whether the SCell is a semi-unknown SCell with respect to the UE; and performing an SCell activation procedure based at least in part on the determination of whether the SCell is a semi-unknown SCell with respect to the UE.

In some implementations, the method includes determining whether the SCell is a semi-unknown SCell to the UE based on a measurement status of the SCell.

In some implementations, the SCell is a semi-unknown SCell to the UE when the measurement status is indicative of the SCell having been measured by the UE, and the measurement status is indicative of the SCell having been measured by the UE when at least one of a cell synchronization operation or a cell measurement operation has been performed for the SCell by the UE.

In some implementations, the method includes receiving, from the base station, a request for the measurement status of the SCell, and reporting, to the base station, the measurement status of the SCell in response to the request, in which the UE and the base station are configured to skip an L3 measurement and proceed to an L1 reference signal received power (RSRP) measurement of the SCell activation procedure when the measurement status is indicative of the SCell having been measured by the UE. In some implementations, the request is an aperiodic request received before receipt of the indication to activate the SCell.

In some implementations, the method includes reporting, to the base station, the measurement status of the SCell in response to receiving the indication to activate the SCell, in which the UE and the base station are configured to skip an L3 measurement and proceed to an L1-RSRP measurement of the SCell activation procedure when the measurement status is indicative of the SCell having been measured by the UE.

In some implementations, the method includes receiving, from the base station, a request for the measurement status of the SCell, and reporting, to the base station, the measurement status of the SCell and a strongest measured synchronization signal block (SSB) index of the SCell in response to the request, in which the UE and the base station are configured to skip an L3 measurement, an L1 measurement, and an L1 measurement report of the SCell activation procedure when the measurement status is indicative of the SCell having been measured by the UE.

In some implementations, the method includes reporting, to the base station, the measurement status of the SCell and a strongest measured SSB index of the SCell in response to receiving the indication to activate the SCell, in which the UE and the base station are configured to skip an L3 measurement, an L1 measurement, and an L1 measurement report of the SCell activation procedure when the measurement status is indicative of the SCell having been measured by the UE.

In some implementations, the method includes determining whether the SCell is a semi-unknown SCell to the UE based on whether an L3 measurement has been performed for the SCell by the UE.

In some implementations, the method includes determining that the L3 measurement has been performed for the SCell by the UE, and reporting, to the base station, the L3 measurement results, in which the UE and the base station are configured to skip an L3 measurement, an L1 measurement, and an L1 measurement report of the SCell activation procedure in response to determining that the L3 measurement has been performed for the SCell by the UE.

In some implementations, the method includes receiving, from the base station, a request for one or more L3 measurements for one or more component carriers, and reporting, to the base station, a strongest L3 measurement result of the one or more L3 measurements, or one or more of the L3 measurement results that satisfy a threshold.

In some implementations, the method includes determining whether the SCell is a semi-unknown SCell to the UE based on a time interval between configuration of the SCell to the UE and the indication to activate the SCell. In some implementations, the SCell is a semi-unknown SCell to the UE if the time interval is greater than an SCell measurement period. In some implementations, the SCell is a semi-unknown SCell to the UE if the time interval is greater than a threshold configured by the base station.

In some implementations, the method includes skipping one or more measurement operations during the SCell activation procedure in response to a determination that the SCell is a semi-unknown SCell to the UE. In some implementations, the one or more measurement operations skipped during activation of the SCell include at least one of an L1 measurement operation or an L3 measurement operation.

In some implementations, the method includes determining a delay for the SCell activation procedure in response to a determination that the SCell is a semi-unknown SCell to the UE. In some implementations, the delay for the SCell activation procedure is reduced relative to an SCell activation delay for an SCell that is unknown to the UE.

In general, in an aspect, a method to be performed by a base station includes: transmitting, to a UE, an indication to activate a SCell; determining whether the SCell is a semi-unknown SCell with respect to the UE; and performing an SCell activation procedure based at least in part on the determination of whether the SCell is a semi-unknown SCell with respect to the UE.

In some implementations, the method includes determining whether the SCell is a semi-unknown SCell to the UE based on a measurement status of the SCell received from the UE. In some implementations, the SCell is a semi-unknown SCell to the UE when the measurement status is indicative of the SCell having been measured by the UE.

In some implementations, the method includes transmitting, to the UE, a request for the measurement status of the SCell, and receiving, from the UE, the measurement status of the SCell in response to the request, in which the UE and the base station are configured to skip an L3 measurement and proceed to an L1-RSRP measurement of the SCell activation procedure when the measurement status is indicative of the SCell having been measured by the UE. In some implementations, the request is an aperiodic request transmitted before transmission of the indication to activate the SCell.

In some implementations, the method includes receiving, from the UE, the measurement status in response to the indication to activate the SCell, in which the UE and the base station are configured to skip an L3 measurement and proceed to an L1-RSRP measurement of the SCell activation procedure when the measurement status is indicative of the SCell having been measured by the UE.

In some implementations, the method includes transmitting, to the UE, a request for the measurement status of the SCell, and receiving, from the UE, the measurement status of the SCell and a strongest measured SSB index of the SCell in response to the request, in which the UE and the base station are configured to skip an L3 measurement, L1 measurement, and an L1 measurement report, and proceed to a TCI activation of the SCell activation procedure when the measurement status is indicative of the SCell having been measured by the UE.

In some implementations, the method includes receiving, from the UE, the measurement status in response to the indication to activate the SCell, in which the UE and the base station are configured to skip an L3 measurement and proceed to an L1-RSRP measurement of the SCell activation procedure when the measurement status is indicative of the SCell having been measured by the UE.

In some implementations, the method includes receiving, from the UE, an L3 measurement report for the SCell during the SCell activation procedure, the L3 measurement having been performed by the UE before transmission of the indication to activate the SCell, and in response to receiving the L3 measurement, transmitting, to the UE, a TCI state activation command based at least in part on the L3 measurement.

In some implementations, the method includes transmitting, to the UE, a request for one or more L3 measurements for one or more component carriers, and receiving, from the UE, a strongest L3 measurement report of the one or more L3 measurement reports, or one or more of the L3 measurement reports that satisfy a threshold.

In some implementations, the method includes skipping one or more operations of the SCell activation procedure in response to a determination that the SCell is a semi-unknown SCell to the UE.

In some implementations, the method includes adjusting a timing of one or more operations of the SCell activation procedure in response to a determination that the SCell is a semi-unknown SCell to the UE. In some implementations, adjusting the timing of the one or more operations of the SCell activation procedure includes adjusting a timing for receipt of a L1-RSRP report by the UE. In some implementations, adjusting the timing of the one or more operations of the SCell activation procedure includes adjusting a timing for transmission of a TCI state activation command to the UE.

In general, in an aspect, a method to be performed by a UE includes: determining, based on an information element (IE), a mechanism for TCI activation in an SCell, and using the mechanism for activating a TCI state in the SCell.

In some implementations, the mechanism includes a timer that specifies a time range for waiting for receiving a TCI command from a network after a SCell activation command is received from the network.

In some implementations, using the mechanism for activating the TCI state in the SCell includes: starting the timer in response to receiving the SCell activation command from the network; determining that the TCI command is received from the network prior to the timer expiring; and activating the TCI state based on the TCI command.

In some implementations, using the mechanism for activating the TCI state in the SCell includes: starting the timer in response to receiving the SCell activation command from the network; determining that the TCI command has not been received prior to the timer expiring; and selecting, from a plurality of TCI states and based on measurements of the plurality of TCI states, the TCI state for activation. In some implementations, the measurements are L1-RSRP measurements.

In some implementations, the time range is preconfigured by the wireless network or preconfigured in the UE.

In some implementations, the IE is TCIWaitingTime-r18.

In some implementations, the mechanism is a network configuration indicating whether the TCI activation of the SCell is explicitly indicated.

In some implementations, using the mechanism for activating the TCI state in the SCell includes: receiving the network configuration from the wireless network; determining, based on the network configuration, that the TCI activation of the SCell is explicitly indicated; receiving a TCI command from the wireless network; and activating the TCI state based on the TCI command.

In some implementations, using the mechanism for activating the TCI state in the SCell includes: receiving the network configuration from the wireless network; determining, based on the network configuration, that the TCI activation of the SCell is not explicitly indicated; and selecting, from multiple of TCI states and based on measurements of the multiple TCI states, the TCI state for activation.

In general, in an aspect, a non-transitory computer storage medium is encoded with instructions that, when executed by at least one processor, cause the at least one processor to perform any of the foregoing aspects and implementations.

In general, in an aspect, a system includes at least one processor and at least one storage device storing instructions that, when executed by the at least one processor, cause the at least one processor to perform any of the foregoing aspects and implementations.

In general, in an aspect, an apparatus includes at least one baseband processor configured to perform any of the foregoing aspects and implementations.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example secondary cell (SCell) activation procedure, according to some implementations.

FIG. 2 illustrates example scenarios for activation of an SCell, according to some implementations.

FIG. 3 illustrates a wireless network, according to some implementations.

FIGS. 4-6 illustrate flowcharts of example methods, according to some implementations.

FIG. 7 illustrates a user equipment (UE), according to some implementations.

FIG. 8 illustrates an access node, according to some implementations.

### DETAILED DESCRIPTION

To increase network capacity and data rate, some wireless communication networks utilize carrier aggregation in which multiple serving cells are aggregated together to serve a UE. When carrier aggregation is used, the network can configure the UE with a primary cell (PCell) and one or more secondary cells (SCells) (e.g., via radio resource control (RRC) signaling). Once configured, SCells can be dynamically activated and deactivated (e.g., via medium access control (MAC) control element (CE) commands) to account for changes in network traffic, movement of the UE, or any of a variety of other reasons.

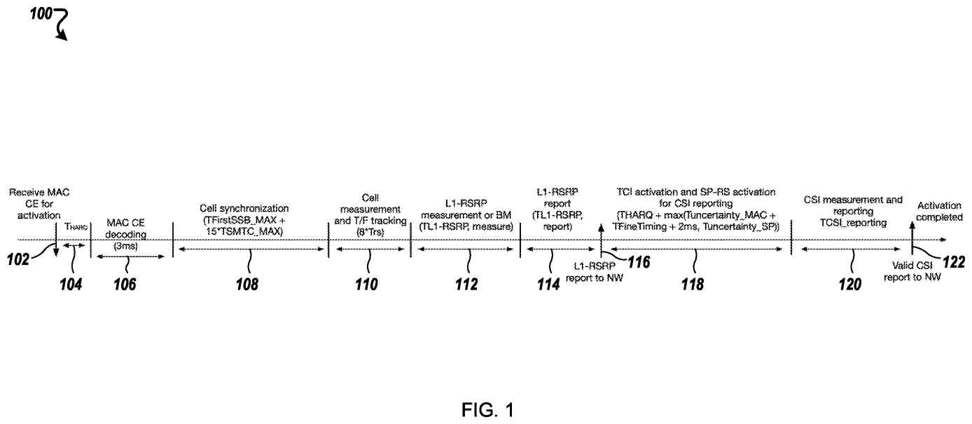

During SCell activation, the UE performs a sequence of operations to prepare the UE and the SCell for subsequent communications. For example, FIG. 1 illustrates an SCell activation procedure 100, according to some implementations. Initially, the UE receives 102 an SCell activation command from the network (e.g., from a base station). The SCell activation command can be in a form of a MAC CE command indicating the SCell to be activated (sometimes referred to as the target SCell). Upon receipt of the SCell activation command, the UE can acknowledge the command through a hybrid automatic repeat request acknowledgement (HARQ-ACK) to the network during a period 104 (T_{HARQ}). The UE then decodes the SCell activation command during a period 106, which can be up to 3 ms in this example.

The UE then performs a cell synchronization operation during a period 108, followed by a cell measurement operation and time and frequency (T/F) tracking during a period 110. In this example, the period 108 is up to T_{FirstSSB_MAX}+15*T_{SMTC_MAX}, and the period 110 is up to 8*Trs. From here, the UE performs L1 reference signal received power (RSRP) measurements on some or all of the received synchronization signal blocks (SSBs) from the target SCell during a period 112 (T_{L1-RSRP, measure}). After completing the L1-RSRP measurements, the UE generates a L1-RSRP report during a period 114 (T_{L1-RSRP, report}) and transmits 116 the L1-RSRP report to the network.

The network selects the optimal beam for transmission to the UE based on the received report. Once the transmission beam has been selected, the network can indicate an SSB (e.g., SSB index) corresponding to the selected beam via a MAC-CE transmission configuration indication (TCI) state activation command that is transmitted to the UE after an uncertainty period (T_{UNCERTAINTY_MAC}). In some examples, the network can also perform semi-persistent channel state information reference signal (CSI-RS) resource set activation. Upon receipt of the TCI state activation command, the UE transmits a HARQ-ACK acknowledging the command and performs a fine timing process on the identified SSB for the target SCell. In this example, TCI state activation (and semi-persistent CSI-RS resource set activation) occurs during a period 118, which can be up to T_{HARQ}+max (T_{uncertainty_MAC}+T_{FineTiming}+2 ms, T_{uncertainty_SP}).

After TCI state activation, the UE can perform a CSI measurement and reporting process. In general, the CSI reporting process can include receiving a CSI-RS transmitted from the target SCell and performing measurements on the received CSI-RS to generate a CSI report (or channel quality index (CQI) report) during a period 120 (T_{CSI_reporting}). The UE then transmits the report 122 to the network, thereby completing activation of the SCell.

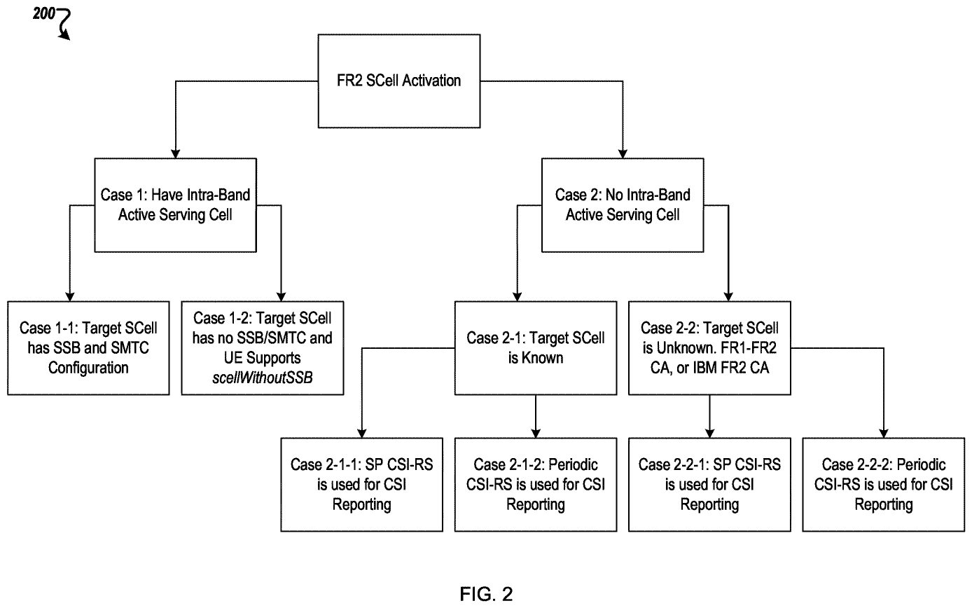

As can be seen from the discussion of the SCell activation process 100, the amount of time required to perform SCell activation can be significant. To promote efficiency and ensure consistent operation across a wide range of devices, the 3GPP has standardized the operations performed by the UE and network (as well as the resultant delay) during activation of an SCell in various scenarios. For example, FIG. 2 illustrates scenarios 200 for activation of an SCell in frequency range 2 (FR2), and Table 1 illustrates the corresponding SCell activation delay for the respective scenario, as defined in Release 17 of 3GPP Technical Specification (TS) 38.133, section 8.3.2.

| Case ID | Requirement |
|---|---|
| Case 1-1 | T_{FirstSSB} + 5 ms |
| Case 1-2 | 3 ms |
| Case 2-1-1 | 3 ms + max(T_{uncertainty}_{_{—}}_{MAC} + T_{FineTiming} + 2 ms, T_{uncertainty}_{_{—}}_{SP}) |
| Case 2-1-2 | max(T_{uncertainty}_{_{—}}_{MAC} + 5 ms + T_{FineTiming}, T_{uncertainty}_{_{—}}_{RRC} + T_{RRC}_{_{—}}_{delay} − T_{HARQ}) |
| Case 2-2-1 | 6 ms + T_{FirstSSB}_{_{—}}_{MAX} + 15*T_{SMTC}_{_{—}}_{MAX} + 8*Tᵣₛ + T_{L1-RSRP}_{, measure} + T_{L1-RSRP}_{, report} + |
| | T_{HARQ} + max(T_{uncertainty}_{_{—}}_{MAC} + T_{FineTiming} + 2 ms, T_{uncertainty}_{_{—}}_{SP}) |
| Case 2-2-2 | 3 ms + T_{FirstSSB}_{_{—}}_{MAX} + 15*T_{SMTC}_{_{—}}_{MAX} + 8*Tᵣₛ + T_{L1-RSRP}_{, measure} + T_{L1-RSRP}_{, report} + |
| | max {(T_{HARQ} + T_{uncertainty}_{_{—}}_{MAC} + 5 ms + T_{FineTiming}), (T_{uncertainty}_{_{—}}_{RRC} + T_{RRC}_{_{—}}_{delay})}. |

As shown in FIG. 2, in some instances, the operations and delay associated with SCell activation can depend in part on whether the SCell is known or unknown to the UE. For example, when the UE is activating an unknown SCell in FR2 according to Case 2-2-1, the SCell activation delay is 6 ms+T_{FirstSSB_MAX}+15*T_{SMTC_MAX}+8*Tᵣₛ+T_{L1-RSRP, measure}+T_{L1-RSRP, report}+T_{HARQ}+max(T_{uncertainty_MAC}+T_{FineTiming}+2 ms, T_{uncertainty_SP}), as illustrated by the SCell activation procedure 100 shown in FIG. 1. On the other hand, if the same SCell is known to the UE (Case 2-1-1), the UE and network can skip certain operations in the SCell activation procedure (e.g., cell synchronization, cell measurement and T/F tracking, L1-RSRP measurement or beam measurement, and L1-RSRP report), and the SCell activation delay can be reduced to 3 ms+max (T_{uncertainty_MAC}+T_{FineTiming}+2 ms, T_{uncertainty_SP}).

For an FR2 SCell to qualify as a known SCell to the UE, the UE must have sent a valid L3-RSRP report before receipt of the SCell activation command, as described in Release 17 of 3GPP TS 38.133, section 8.3.2. Otherwise, the SCell is considered unknown to the UE. However, categorizing SCells as known or unknown in this way can result in inefficiencies and redundant measurements. For example, if a UE has measured an SCell but has not had a chance to report the measurement to the network, the SCell will be deemed unknown to the UE. Thus, the UE will need to revert to the unknown procedure when activating the UE, resulting in duplicate measurements and longer SCell activation.

Another issue regarding SCell activation relates to TCI activation. Currently, a UE activating an unknown FR2 SCell needs to wait for a period (e.g., T_{uncertainty_MAC} in FIG. 1) to receive a TCI command from the network. To save the uncertainty time in SCell activation, a default TCI determination method can be considered. Such a default can be based on the best L1-RSRP, thereby obviating the need for the UE to wait for the TCI activation command from the network. For example, during activation of an unknown FR2 SCell, the TCI of PDCCH/PDSC/CSI-RS can be associated with the best L1-RSRP report if no MAC CE or RRC indication for TCI is sent to the UE. As another example, during the SCell activation, only the TCI from CSI-RS used for CQI needs to be configured. The PDCCH/PDSCH can follow the same TCI state information as CSI-RS. In this way, the PDCCH/PDSCH TCI configuration can be saved and the SCell activation delay can be reduced accordingly. However, using this default can present backward compatibility issues. For example, some networks may still want to activate specific TCI to UE after the L1-RSRP report. Further, the 3GPP standards do not currently provide a means for the UE to know if it shall use the default TCI determination or wait for network's TCI activation command.

The present disclosure describes techniques for improving SCell activation through cell condition and TCI enhancements. In accordance with an aspect of the present disclosure, a new condition of semi-unknown (or semi-known) for a target FR2 SCell is defined. In some implementations, the semi-unknown condition can be determined based on an indication from the UE, such as an indication of a measurement status of the SCell or a report of a previously performed L3 measurement, among others. Alternatively, or in addition, the semi-unknown condition can be defined based on a time interval between RRC configuration of the SCell to the UE and the MAC CE command activating the SCell at the UE. By defining the semi-unknown at both the UE and network, the amount of time needed for SCell activation can be reduced. For example, on the UE side, the UE can skip or omit one or more measurement operations (e.g., L3 measurement and/or beam measurement, among others) when the SCell is semi-unknown, thereby reducing the SCell activation delay relative to activation of an unknown SCell. Similar reductions are achieved on the network side, as the network can perform earlier scheduling and/or directly activate TCI for the UE when the SCell is semi-unknown.

The present disclosure also describes techniques for default TCI determination with backwards compatibility. In this manner, the uncertainty time for TCI activation can be saved without creating conflicts in legacy systems.

While aspects may be described herein in the context of activation of an SCell operating in FR2, aspects of the present disclosure can also be applied to activation of SCells operating in other frequency ranges, such as FR1.

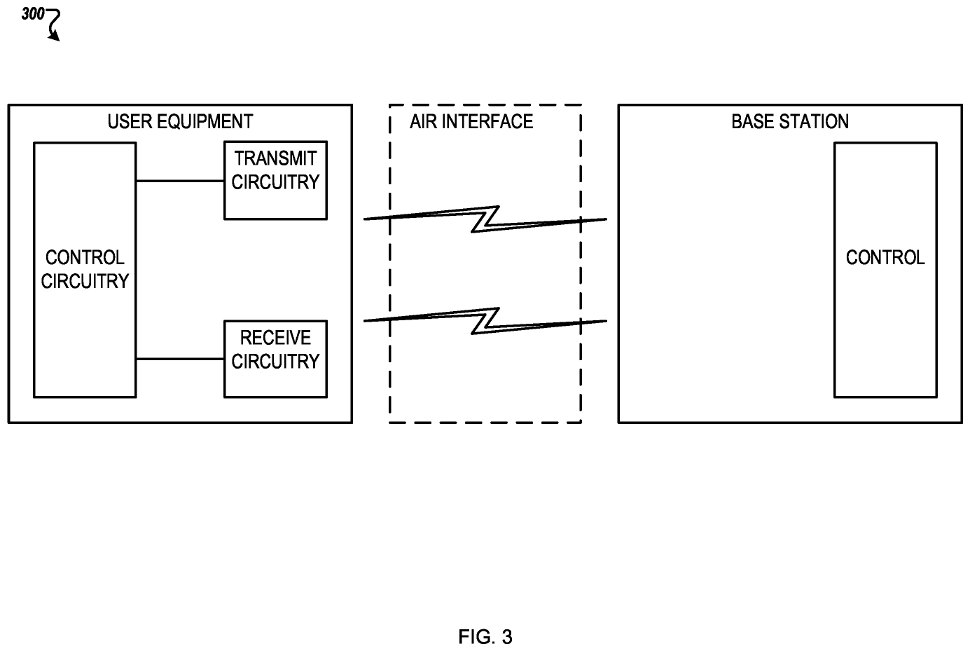

FIG. 3 illustrates a wireless network 300, according to some implementations. The wireless network 300 includes a UE 302 and a base station 304 connected via one or more channels 306A, 306B across an air interface 308. The UE 302 and base station 304 communicate using a system that supports controls for managing the access of the UE 302 to a network via the base station 304.

In some implementations, the wireless network 300 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 300 may be a E-UTRA (Evolved Universal Terrestrial Radio Access)-NR Dual Connectivity (EN-DC) network, or a NR-EUTRA Dual Connectivity (NE-DC) network. However, the wireless network 300 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 300, the UE 302 and any other UE in the system may be, for example, laptop computers, smartphones, tablet computers, machine-type devices such as smart meters or specialized devices for healthcare, intelligent transportation systems, or any other wireless devices with or without a user interface. In network 300, the base station 304 provides the UE 302 network connectivity to a broader network (not shown). This UE 302 connectivity is provided via the air interface 308 in a base station service area provided by the base station 304. In some implementations, such a broader network may be a wide area network operated by a cellular network provider, or may be the Internet. Each base station service area associated with the base station 304 is supported by antennas integrated with the base station 304. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 302 includes control circuitry 310 coupled with transmit circuitry 312 and receive circuitry 314. The transmit circuitry 312 and receive circuitry 314 may each be coupled with one or more antennas. The control circuitry 310 may include various combinations of application-specific circuitry and baseband circuitry. The transmit circuitry 312 and receive circuitry 314 may be adapted to transmit and receive data, respectively, and may include radio frequency (RF) circuitry or front-end module (FEM) circuitry.

In various implementations, aspects of the transmit circuitry 312, receive circuitry 314, and control circuitry 310 may be integrated in various ways to implement the operations described herein. The control circuitry 310 may be adapted or configured to perform various operations such as those described elsewhere in this disclosure related to a UE. For instance, the control circuitry 310 can determine whether an SCell is a semi-unknown SCell to the UE based on, for example, a measurement status of the SCell and/or a time interval between configuration of the SCell to the UE and the SCell activation command, as described herein. The control circuitry 310 can also perform (or assist with performing) an SCell activation procedure based at least in part on whether the SCell is a semi-unknown SCell to the UE.

The transmit circuitry 312 can perform various operations described in this specification. For example, the transmit circuitry 312 can transmit to the base station 304 an indication of the measurement status of an SCell, an indication that the SCell is a semi-unknown SCell, and/or other information related to the determination of whether the SCell is a semi-unknown SCell. The transmit circuitry 312 can also transmit to the base station 304 information related to activation of an SCell (e.g., L1 and/or L3 measurements, HARQ-ACKs, etc.). Additionally, the transmit circuitry 312 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 312 may be configured to receive block data from the control circuitry 310 for transmission across the air interface 308.

The receive circuitry 314 can perform various operations described in this specification. For instance, the receive circuitry 314 can receive a request from the base station 304 for information related to the determination of whether an SCell is a semi-unknown SCell to the UE, such as an SCell measurement status. The receive circuitry 314 can also receive from the base station 304 an indication to activate an SCell (e.g., a MAC CE SCell activation command), a TCI state activation command, and other information related to SCell activation. Additionally, the receive circuitry 314 may receive a plurality of multiplexed downlink physical channels from the air interface 308 and relay the physical channels to the control circuitry 310. The plurality of downlink physical channels may be multiplexed according to TDM or FDM along with carrier aggregation. The transmit circuitry 312 and the receive circuitry 314 may transmit and receive both control data and content data (e.g., messages, images, video, etc.) structured within data blocks that are carried by the physical channels.

FIG. 3 also illustrates the base station 304. In implementations, the base station 304 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 304 that operates in an NR or 5G wireless network 300, and the term “E-UTRAN” or the like may refer to a base station 304 that operates in an LTE or 4G wireless network 300. The UE 302 utilizes connections (or channels) 306A, 306B, each of which includes a physical communications interface or layer.

The base station 304 circuitry may include control circuitry 316 coupled with transmit circuitry 318 and receive circuitry 320. The control circuitry 316 can perform various operations described in this specification, including determining whether an SCell is a semi-unknown SCell to the UE, as well as performing (or assisting with performing) an SCell activation procedure based at least in part on whether the SCell is a semi-unknown SCell to the UE. The transmit circuitry 318 and receive circuitry 320 may each be coupled with one or more antennas that may be used to enable communications via the air interface 308. The transmit circuitry 318 and receive circuitry 320 may be adapted to transmit and receive data, respectively, to any UE connected to the base station 304. The transmit circuitry 318 may transmit downlink physical channels includes of a plurality of downlink subframes. The transmit circuitry 318 can also transmit a request to the UE 302 for information related to the determination of whether an SCell is a semi-unknown SCell to the UE, such as an SCell measurement status. The transmit circuitry 318 can also transmit to the UE 302 an indication to activate an SCell (e.g., a MAC CE SCell activation command), a TCI state activation command, and other information related to SCell activation. The receive circuitry 320 may receive a plurality of uplink physical channels from various UEs, including the UE 302. The receive circuitry 320 can also receive from the UE 302 an indication of the measurement status of an SCell, an indication that the SCell is a semi-unknown SCell, and/or other information related to the determination of whether the SCell is a semi-unknown SCell. The receive circuitry 320 can also receive from the UE 302 information related to activation of an SCell (e.g., L1 and/or L3 measurements, HARQ-ACKs, etc.).

In FIG. 3, the one or more channels 306A, 306B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 302 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

As discussed above, the operations and delay associated with SCell activation can depend in part on whether the SCell is known or unknown. Whether an SCell operating in FR2 is considered known or unknown to a UE is defined in 3GPP TS 38.133, section 8.3.2 as follows:

For the first SCell activation in FR2 bands, the SCell is known if it has been meeting the following conditions:

During the period equal to 4s for UE supporting power class1 and 3s for UE supporting power class 2/3/4 before UE receives the last activation command for PDCCH TCI, PDSCH TCI (when applicable) and semi-persistent CSI-RS for CQI reporting (when applicable):
the UE has sent a valid L3-RSRP measurement report with SSB index SCell
activation command is received after L3-RSRP reporting and no later than the time when UE receives MAC-CE command for TCI activation,

During the period from L3-RSRP reporting to the valid CQI reporting, the reported SSBs with indexes remain detectable according to the cell identification conditions specified in TS 38.133 [6] clause 9.2 and 9.3, and the TCI state is selected based on one of the latest reported SSB indexes.

Otherwise, the first SCell in FR2 band is unknown. The requirement for unknown SCell applies provided that the activation commands for PDCCH TCI, PDSCH TCI (when applicable), semi-persistent CSI-RS for CQI reporting (when applicable), and configuration message for TCI of periodic CSI-RS for CQI reporting (when applicable) are based on the latest valid L1-RSRP reporting.

Categorizing SCells as known or unknown in the manner described in Release 17 of the 3GPP standard can result in inefficiencies and redundant measurements. For example, if a UE has measured an SCell but has not had a chance to report the measurement to the network, the SCell will be deemed unknown to the UE. Thus, the UE will need to revert to the unknown procedure when activating the UE, resulting in duplicate measurements and longer SCell activation.

In accordance with an aspect of the present disclosure, a new condition of semi-unknown (or semi-known) for a target FR2 SCell is defined. When an SCell is determined to be semi-unknown to the UE, as described herein, the UE and network can reduce the amount of time needed for SCell activation. For example, on the UE side, the UE can skip or omit one or more measurement operations (e.g., L3 measurement and/or beam measurement, among others) when the SCell is semi-unknown, thereby reducing the SCell activation delay relative to activation of an unknown SCell. Similar reductions are achieved on the network side, as the network can perform earlier scheduling and/or directly activate TCI for the UE when the SCell is semi-unknown. If an SCell is determined not to be semi-unknown (or known) to the UE, the UE and the network can default to unknown SCell operation.

In some implementations, the semi-unknown condition can be determined based on an indication from the UE, rather than, for example, the formal L3 reporting needed before receipt of the activation command for the SCell to be considered a known SCell. For example, the semi-unknown condition can be determined based on a measurement status of a target SCell. Such a measurement status can be determined based on, for example, whether one or more measurement operations, such as a cell synchronization operation and/or a cell measurement operation, among others, have been performed for the SCell by the UE before receipt of the MAC CE activation command identifying the target SCell. Values for the measurement status can include, for example, “measured” or “not measured,” in which a value of measured is indicative of a semi-unknown SCell, and a value of not measured is indicative of a non-semi-unknow or unknown SCell. Other values can include “valid measurement” or “no valid measurement,” or “known” or “unknown,” among others.

In some implementations, the network (e.g., a base station) can use an aperiodic trigger or other trigger to trigger the UE to request the measurement status of a target SCell. The aperiodic trigger can be DCI, or MAC, or RRC based. In an example use case, before the network sends the SCell activation command to the UE, the network sends an aperiodic request to UE to ask the measurement status of the SCell, and the UE responds to indicate the measurement status. If the SCell is semi-unknown to the UE based on the measurement status, then the network and the UE may skip the L3 measurement and directly go to the L1-RSRP measurement.

In some implementations, the UE can automatically indicate the measurement status upon receipt of the MAC CE command initiating SCell activation. In an example use case, the network sends the MAC CE SCell activation command to the UE; when the UE receives and decodes the MAC CE message to activate the target SCell, the UE will feedback the measurement status of target SCell to the network. If the SCell is semi-unknown to the UE based on the measurement status, then the network and the UE may skip L3 measurement and directly go to the L1-RSRP measurement.

In some implementations, the network can send an aperiodic trigger to the UE, and the UE can indicate both the measurement status of the target FR2 SCell and the strongest (e.g., highest power) measured SSB index. In an example use case, before the network sends the SCell activation command to the UE, the network sends an aperiodic request to the UE to ask the measurement status of the SCell, and the UE responds to indicate the measurement status and the strongest measured SSB index. Then, the network and the UE may skip the L3/L1 measurements and directly go to the TCI activation stage depending on the measurement status of the SCell.

In some implementations, when the UE receives the MAC CE SCell activation command, the UE can automatically indicate both the measurement status and the strongest measured SSB index. In an example use case, the network sends the SCell activation command to the UE; when the UE receives and decodes the MAC CE message to activate the target SCell, the UE will feedback the measurement status of the target SCell and the strongest measured SSB index to network. Then the network and the UE may skip L3/L1 measurements and directly go to the TCI activation stage depending on the measurement status of the SCell.

In some implementations, the semi-unknown condition and/or the measurement status of a target SCell can be determined based on whether the UE has performed an L3 measurement procedure or generated an L3 report for the target SCell before receipt of the SCell activation command. If the UE sends the L3 report to network after receipt of the MAC CE SCell activation command, both the network and the UE can assume that the UE will skip one or more measurement operations, such as those for unknown SCells (e.g., L3 cell search/measurement and beam measurement), and perform the SCell activation procedure as if the SCell were known to the UE. In an example use case, the network can send the SCell activation command to the UE, and the UE can initiate the SCell activation procedure according to the unknown SCell procedure. If an L3 measurement has previously been performed (e.g., before receipt of the MAC CE SCell activation command) by the UE for the target SCell, the UE reports the L3 results to network during the SCell activation procedure. Then, the UE and the network can both assume that the UE will skip the unfinished L3 and/or L1 measurement, and that the network can directly transmit the TCI state activation command to the UE.

In some implementations, the network can send an aperiodic request to the UE for the L3 measurement(s) (e.g., L3-RSRP) on different component carries. In response, the UE can report the best (e.g., highest power) L3-RSRP, or all L3-RSRP above a certain threshold (e.g., a power threshold) based on the aperiodic request.

In some implementations, the semi-unknown condition can be defined and determined based on a time interval between RRC configuration of the SCell to the UE (e.g., SCell addition) and the MAC CE SCell activation command (e.g., SCell activation). If this interval is greater than at least one SCell measurement period, the SCell can be treated as semi-unknown to the UE; and the network and the UE may skip the L3 measurement and directly go to the L1-RSRP measurement. As a non-limiting example, the measurement period can be a specified measurement sample*scaling factor*SMTC periodicity.

In some implementations, the network to configure the interval with which an SCell will be considered semi-unknown to the UE. For example, the network can trigger a timer to UE; if the timer is expired, the measurement result for the SCell shall be assumed available, and the SCell shall be considered semi-unknown to the UE. This is because the network can assume that the UE has sufficient time to perform measurements on target SCell, even though UE has not sent an L3 report of the measurement results to network. Based on this assumption, the network and the UE may skip the L3 measurement and directly go to the L1-RSRP measurement.

In accordance with an aspect of the present disclosure, a default TCI determination with backwards compatibility can be defined. For example, in some implementations, the UE can be configured with a time range for waiting the TCI from network. If there is no incoming TCI command from network within the time range, then UE can, by default, use the max L1-RSRP related TCI for CQI measurement and PDCCH of the target SCell. The time range can be pre-configured by network, or can be predefined (e.g., 10 ms) in the 3GPP standards.

In some implementations, when the network configures the SCell (e.g., in an SCell addition command), the network will indicate whether the TCI of the SCell will be explicitly indicated or can be based on max L1-RSRP related TCI. If network does not provide this indication, then the UE can fall back to waiting for the TCI activation command from the network.

As a non-limiting example, one or both of the foregoing options can be incorporated into the 3GPP standards standard using the TCIWaitingTime-r18 IE and/or the explicitTCI-r18 IE shown below:

| SCellConfig ::= | SEQUENCE { | |
|---|---|---|
| sCellIndex | SCellIndex, | |
| sCellConfigCommon | ServingCellConfigCommon | OPTIO |

NAL, -- Cond SCellAdd

| | | |
|---|---|---|
| sCellConfigDedicated | ServingCellConfig | OPTIONAL, |

```
-- Cond SCellAddMod
  ...,
  [[
```

| | | |
|---|---|---|
| smtc | SSB-MTC | OPTIONAL -- Need S |

```
  ]],
  [[
  sCellState-
```

| | |
|---|---|
| r16 ENUMERATED {activated} | OPTIONAL, -- Cond |

SCellAddSync
secondaryDRX-GroupConfig-

| | |
|---|---|
| r16 ENUMERATED {true} | OPTIONAL -- Cond DRX- |

```
Config2
  ]],
  [[
```

| preConfGapStatus-r17 | | BIT STRING (SIZE (maxNrofGapId- |
|---|---|---|
| r17)) | OPTIONAL, -- Cond PreConfigMG | |
| goodServingCellEvaluationBFD-r17 | | GoodServingCellEvaluation- |
| r17 | OPTIONAL, -- Need R | |
| sCellSIB20-r17 | SetupRelease { | SCellSIB20- |

| | |
|---|---|
| r17 } | OPTIONAL -- Need M |

]]

| | |
|---|---|
| TCIWaitingTime-r18 | ENUMERATED {ms5, ms10, ...} |
| explicitTCI-r18 | ENUMERATED {true}, |

}

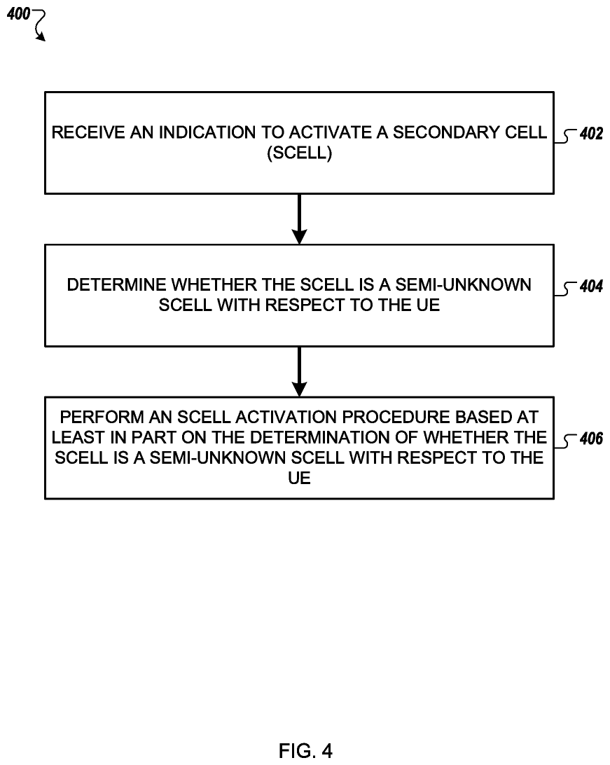

FIG. 4 illustrates a flowchart of an example method 400, according to some implementations. For clarity of presentation, the description that follows generally describes method 400 in the context of the other figures in this description. For example, method 400 can be performed by the UE 102 of FIG. 1. It will be understood that method 400 can be performed, for example, by any suitable system, environment, software, hardware, or a combination of systems, environments, software, and hardware, as appropriate. In some implementations, various steps of method 400 can be run in parallel, in combination, in loops, or in any order.

Operations of the method 400 include receiving an indication to activate a SCell (402). For example, the UE 102 can receive, from the base station 104, a MAC CE SCell activation command indicating the target SCell.

At 404, a determination is made as to whether the SCell is a semi-unknown SCell with respect to the UE. In some implementations, determining whether the SCell is a semi-unknown SCell with respect to the UE is based on a measurement status of the SCell. For example, the SCell can be a semi-unknown SCell with respect to the UE when the measurement status is indicative of the SCell having been measured by the UE; otherwise, the SCell can be considered unknown with respect to the UE. In some implementations, the measurement status is indicative of the SCell having been measured by the UE when at least one of a cell synchronization operation or a cell measurement operation has been performed for the SCell by the UE.

In some implementations, determining whether the SCell is a semi-unknown SCell with respect to the UE is based on a time interval between configuration of the SCell to the UE and the indication to activate the SCell. In some implementations, the SCell is a semi-unknown SCell to the UE if the time interval is greater than an SCell measurement period. In some implementations, the SCell is a semi-unknown SCell to the UE if the time interval is greater than a threshold configured by the base station.

At 406, an SCell activation procedure is performed based at least in part on the determination of whether the SCell is a semi-unknown SCell with respect to the UE. Such a procedure can be performed by, for example, the UE 102 and the base station 104, among others. In some implementations, performing the SCell activation procedure based at least in part on the determination of whether the SCell is a semi-unknown SCell with respect to the UE includes skipping one or more measurement operations during the SCell activation procedure in response to a determination that the SCell is a semi-unknown SCell to the UE. The one or more measurement operations skipped during activation of the SCell can include at least one of an L1 measurement operation or an L3 measurement operation. In some implementations, performing the SCell activation procedure based at least in part on the determination of whether the SCell is a semi-unknown SCell with respect to the UE includes determining a delay for the SCell activation procedure in response to a determination that the SCell is a semi-unknown SCell to the UE. In some implementations, the delay for the SCell activation procedure is reduced relative to an SCell activation delay for an SCell that is unknown to the UE.

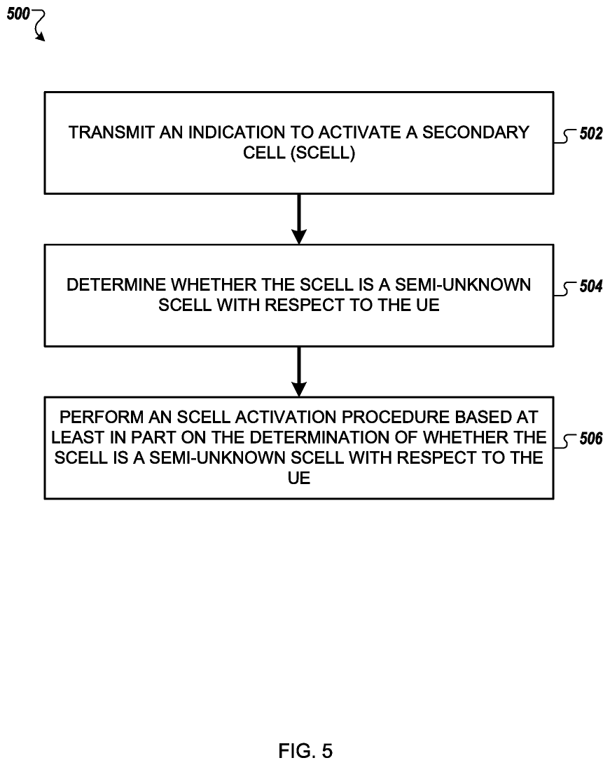

FIG. 5 illustrates a flowchart of an example method 500, according to some implementations. For clarity of presentation, the description that follows generally describes method 500 in the context of the other figures in this description. For example, method 500 can be performed by the base station 104 of FIG. 1. It will be understood that method 500 can be performed, for example, by any suitable system, environment, software, hardware, or a combination of systems, environments, software, and hardware, as appropriate. In some implementations, various steps of method 500 can be run in parallel, in combination, in loops, or in any order.

Operations of the method 500 include transmitting an indication to activate a SCell (502). For example, the base station 104 can transmit, to the UE 102, a MAC CE SCell activation command indicating the target SCell.

At 504, a determination is made as to whether the SCell is a semi-unknown SCell with respect to the UE. In some implementations, the determination of whether the SCell is a semi-unknown SCell with respect to the UE is based on a measurement status of the SCell received from the UE. For example, the SCell can be a semi-unknown SCell with respect to the UE when the measurement status is indicative of the SCell having been measured by the UE; otherwise, the SCell can be considered unknown with respect to the UE. In some implementations, the measurement status is received from the UE in response to an aperiodic request from the UE. In some implementations, the measurement status is received from the UE automatically in response to the indication to activate the SCell.

At 506, an SCell activation procedure is performed based at least in part on the determination of whether the SCell is a semi-unknown SCell with respect to the UE. Such a procedure can be performed by, for example, the UE 102 and the base station 104, among others. In some implementations, performing the SCell activation procedure based at least in part on the determination of whether the SCell is a semi-unknown SCell with respect to the UE includes skipping one or more operations of the SCell activation procedure in response to a determination that the SCell is a semi-unknown SCell with respect to the UE. In some implementations, performing the SCell activation procedure based at least in part on the determination of whether the SCell is a semi-unknown SCell with respect to the UE includes adjusting a timing of one or more operations of the SCell activation procedure in response to a determination that the SCell is a semi-unknown SCell with respect to the UE. Adjusting the timing of the one or more operations of the SCell activation procedure can include adjusting a timing for receipt of a L1-RSRP report by the UE, adjusting a timing for transmission of a TCI state activation command to the UE, or both, among others.

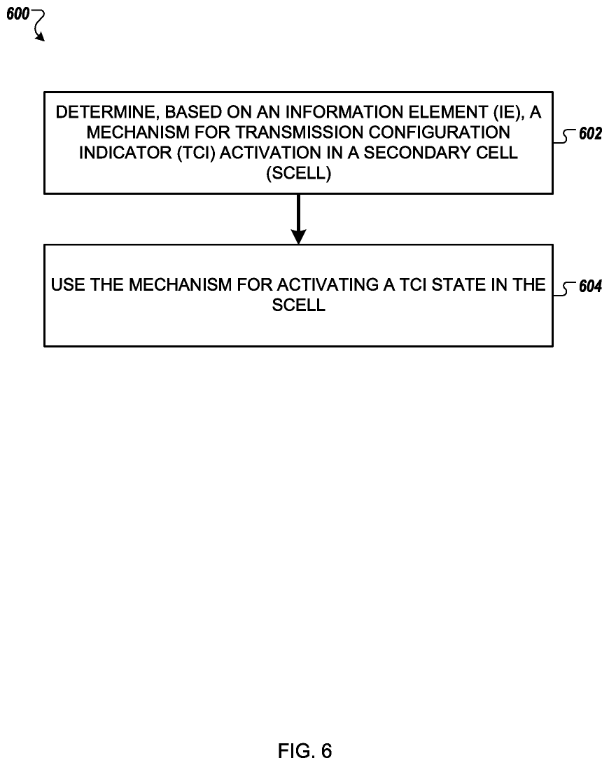

FIG. 6 illustrates a flowchart of an example method 600, according to some implementations. For clarity of presentation, the description that follows generally describes method 600 in the context of the other figures in this description. For example, method 600 can be performed by the UE 102 of FIG. 1. It will be understood that method 600 can be performed, for example, by any suitable system, environment, software, hardware, or a combination of systems, environments, software, and hardware, as appropriate. In some implementations, various steps of method 600 can be run in parallel, in combination, in loops, or in any order.

Operations of the method 600 include determining, based on an IE, a mechanism for TCI activation in a SCell (602). For example, the UE 102 can determine the mechanism for TCI activation in the SCell based on an IE received from the base station 104. In some implementations, the mechanism is a timer that specifies a time range for waiting for receiving a TCI command from a network after a SCell activation command is received from the network. In some implementations, the mechanism is a network configuration indicating whether the TCI activation of the SCell is explicitly indicated. In some implementations, the IE includes a TCIWaitingTime-r18 IE and/or an explicitTCI-r18 IE.

At 604, the mechanism is used for activating a TCI state in the SCell (604). In some implementations, using the mechanism for activating the TCI state in the SCell includes: starting the timer in response to receiving the SCell activation command from the network; determining that the TCI command is received from the network prior to the timer expiring; and activating the TCI state based on the TCI command. In some implementations, using the mechanism for activating the TCI state in the SCell includes: starting the timer in response to receiving the SCell activation command from the network; determining that the TCI command has not been received prior to the timer expiring; and selecting, from multiple TCI states and based on measurements (e.g., L1-RSRP measurements) of the multiple TCI states, the TCI state for activation. In some implementations, the time range is preconfigured by the wireless network or preconfigured in the UE.

In some implementations, using the mechanism for activating the TCI state in the SCell includes: receiving the network configuration from the wireless network; determining, based on the network configuration, that the TCI activation of the SCell is explicitly indicated; receiving a TCI command from the wireless network; and activating the TCI state based on the TCI command. In some implementations, using the mechanism for activating the TCI state in the SCell includes: receiving the network configuration from the wireless network; determining, based on the network configuration, that the TCI activation of the SCell is not explicitly indicated; and selecting, from multiple TCI states and based on measurements of the multiple TCI states, the TCI state for activation.

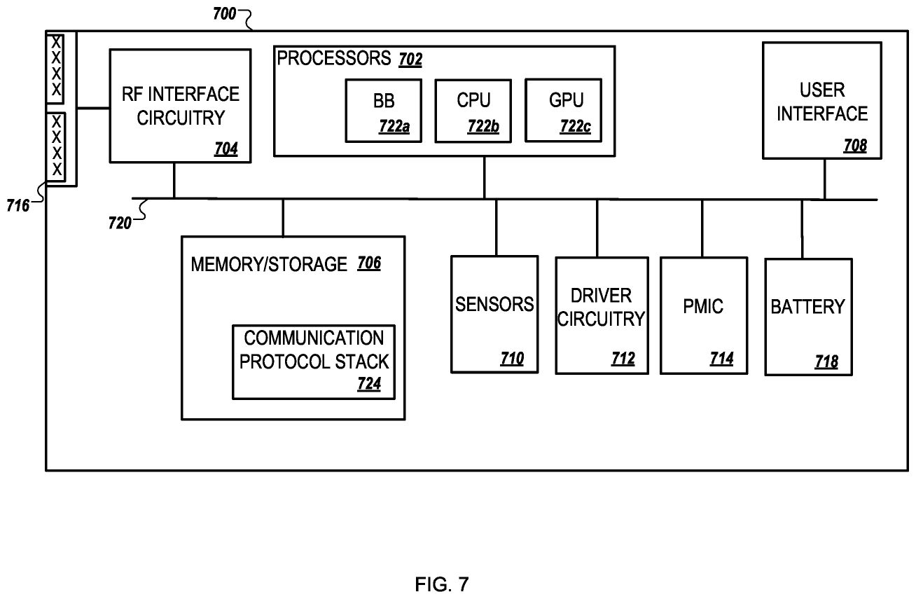

FIG. 7 illustrates a UE 700, according to some implementations. The UE 700 may be similar to and substantially interchangeable with UE 302 of FIG. 3.

The UE 700 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 700 may include processors 702, RF interface circuitry 704, memory/storage 706, user interface 708, sensors 710, driver circuitry 712, power management integrated circuit (PMIC) 714, antenna structure 716, and battery 718. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 720, which may represent any type of interface, input/output, bus (local, system, or expansion), transmission line, trace, optical connection, etc. that allows various circuit components (on common or different chips or chipsets) to interact with one another.

The processors 702 may include processor circuitry such as, for example, baseband processor circuitry (BB) 722A, central processor unit circuitry (CPU) 722B, and graphics processor unit circuitry (GPU) 722C. The processors 702 may include any type of circuitry or processor circuitry that executes or otherwise operates computer-executable instructions, such as program code, software modules, or functional processes from memory/storage 706 to cause the UE 700 to perform operations as described herein.

In some implementations, the baseband processor circuitry 722A may access a communication protocol stack 724 in the memory/storage 706 to communicate over a 3GPP compatible network. In general, the baseband processor circuitry 722A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 704. The baseband processor circuitry 722A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 706 may include one or more non-transitory, computer-readable media that includes instructions (for example, communication protocol stack 724) that may be executed by one or more of the processors 702 to cause the UE 700 to perform various operations described herein. The memory/storage 706 include any type of volatile or non-volatile memory that may be distributed throughout the UE 700. In some implementations, some of the memory/storage 706 may be located on the processors 702 themselves (for example, L1 and L2 cache), while other memory/storage 706 is external to the processors 702 but accessible thereto via a memory interface. The memory/storage 706 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 704 may include transceiver circuitry and radio frequency front module (RFEM) that allows the UE 700 to communicate with other devices over a radio access network. The RF interface circuitry 704 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 716 and proceed to filter and amplify (with a low-noise amplifier) the signal. The signal may be provided to a receiver of the transceiver that downconverts the RF signal into a baseband signal that is provided to the baseband processor of the processors 702.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 716. In various implementations, the RF interface circuitry 704 may be configured to transmit/receive signals in a manner compatible with NR access technologies.

The antenna 716 may include antenna elements to convert electrical signals into radio waves to travel through the air and to convert received radio waves into electrical signals. The antenna elements may be arranged into one or more antenna panels. The antenna 716 may have antenna panels that are omnidirectional, directional, or a combination thereof to enable beamforming and multiple input, multiple output communications. The antenna 716 may include microstrip antennas, printed antennas fabricated on the surface of one or more printed circuit boards, patch antennas, phased array antennas, etc. The antenna 716 may have one or more panels designed for specific frequency bands including bands in FR1 or FR2.

The user interface 708 includes various input/output (I/O) devices designed to enable user interaction with the UE 700. The user interface 708 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 700.

The sensors 710 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 712 may include software and hardware elements that operate to control particular devices that are embedded in the UE 700, attached to the UE 700, or otherwise communicatively coupled with the UE 700. The driver circuitry 712 may include individual drivers allowing other components to interact with or control various input/output (I/O) devices that may be present within, or connected to, the UE 700. For example, driver circuitry 712 may include a display driver to control and allow access to a display device, a touchscreen driver to control and allow access to a touchscreen interface, sensor drivers to obtain sensor readings of sensor circuitry 710 and control and allow access to sensor circuitry 710, drivers to obtain actuator positions of electro-mechanic components or control and allow access to the electro-mechanic components, a camera driver to control and allow access to an embedded image capture device, audio drivers to control and allow access to one or more audio devices.

The PMIC 714 may manage power provided to various components of the UE 700. In particular, with respect to the processors 702, the PMIC 714 may control power-source selection, voltage scaling, battery charging, or DC-to-DC conversion.

In some implementations, the PMIC 714 may control, or otherwise be part of, various power saving mechanisms of the UE 700. A battery 718 may power the UE 700, although in some examples the UE 700 may be mounted deployed in a fixed location, and may have a power supply coupled to an electrical grid. The battery 718 may be a lithium ion battery, a metal-air battery, such as a zinc-air battery, an aluminum-air battery, a lithium-air battery, and the like. In some implementations, such as in vehicle-based applications, the battery 718 may be a typical lead-acid automotive battery.

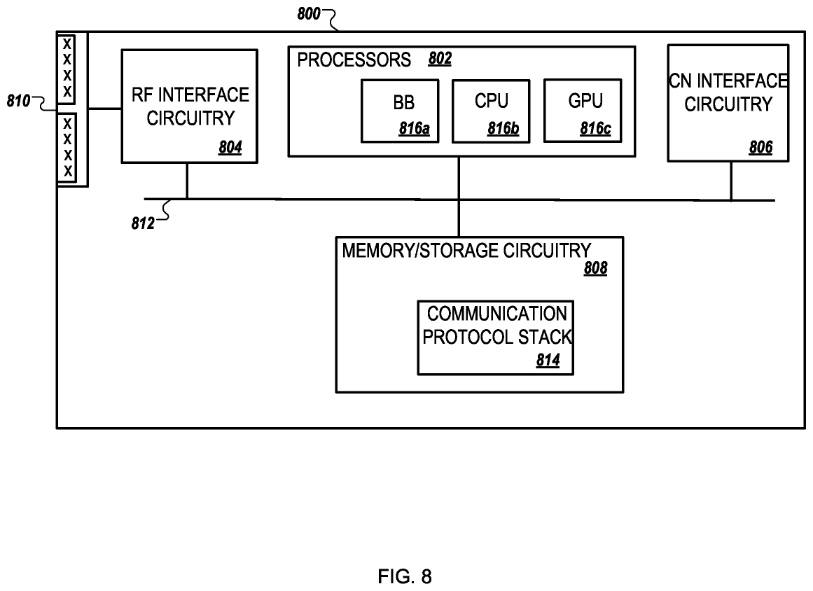

FIG. 8 illustrates an access node 800 (e.g., a base station or gNB), according to some implementations. The access node 800 may be similar to and substantially interchangeable with base station 304. The access node 800 may include processors 802, RF interface circuitry 804, core network (CN) interface circuitry 806, memory/storage circuitry 808, and antenna structure 810.

The components of the access node 800 may be coupled with various other components over one or more interconnects 812. The processors 802, RF interface circuitry 804, memory/storage circuitry 808 (including communication protocol stack 814), antenna structure 810, and interconnects 812 may be similar to like-named elements shown and described with respect to FIG. 7. For example, the processors 802 may include processor circuitry such as, for example, baseband processor circuitry (BB) 816A, central processor unit circuitry (CPU) 816B, and graphics processor unit circuitry (GPU) 816C.

The CN interface circuitry 806 may provide connectivity to a core network, for example, a 5th Generation Core network (5GC) using a 5GC-compatible network interface protocol such as carrier Ethernet protocols, or some other suitable protocol. Network connectivity may be provided to/from the access node 800 via a fiber optic or wireless backhaul. The CN interface circuitry 806 may include one or more dedicated processors or FPGAs to communicate using one or more of the aforementioned protocols. In some implementations, the CN interface circuitry 806 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 800 that operates in an NR or 5G system (for example, a gNB), and the term “E-UTRAN node” or the like may refer to an access node 800 that operates in an LTE or 4G system (e.g., an eNB). According to various implementations, the access node 800 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 800 may be implemented as one or more software entities running on server computers as part of a virtual network, which may be referred to as a CRAN and/or a virtual baseband unit pool (vBBUP). In V2X scenarios, the access node 800 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-51. (canceled)

52. One or more processors configured, when executing instructions stored in memory, to perform operations comprising:
receiving an indication to activate a secondary cell (SCell);
after receiving the indication to activate the SCell, reporting one or more L3 measurement results for the SCell; and
performing an SCell activation procedure based at least in part on the reporting of the one or more L3 measurement results for the SCell after receiving the indication to activate the SCell.

53. The one or more processors of claim 52, wherein the SCell comprises an unknown SCell.

54. The one or more processors of claim 52, wherein the one or more processors are configured to perform at least one of a cell synchronization operation or a cell measurement operation for the SCell before receiving the indication to activate the SCell.

55. The one or more processors of claim 52, wherein reporting the one or more L3 measurement results comprises causing radio frequency (RF) circuitry to transmit, to a base station, the one or more L3 measurement results.

56. The one or more processors of claim 52, wherein performing the SCell activation procedure based at least in part on the reporting of the one or more L3 measurement results for the SCell after receiving the indication to activate the SCell comprises:
skipping at least one of an L3 measurement, an L1 measurement, or an L1 measurement report of the SCell activation procedure based at least in part on reporting the one or more L3 measurement results for the SCell.

57. The one or more processors of claim 52, wherein performing the SCell activation procedure based at least in part on the reporting of the one or more L3 measurement results for the SCell after receiving the indication to activate the SCell comprises:
performing the SCell activation procedure according to an SCell activation delay associated with reporting of the one or more L3 measurement results for the SCell after receiving the indication to activate the SCell.

58. The one or more processors of claim 57, wherein the one or more processors are configured to report channel state information (CSI) for the SCell after the SCell activation delay.

59. A method, comprising:
receiving an indication to activate a secondary cell (SCell);
after receiving the indication to activate the SCell, reporting one or more L3 measurement results for the SCell; and
performing an SCell activation procedure based at least in part on the reporting of the one or more L3 measurement results for the SCell after receiving the indication to activate the SCell.

60. The method of claim 59, wherein the SCell comprises an unknown SCell.

61. The method of claim 59, further comprising:
performing at least one of a cell synchronization operation or a cell measurement operation for the SCell before receiving the indication to activate the SCell.

62. The method of claim 59, wherein reporting the one or more L3 measurement results comprises causing radio frequency (RF) circuitry to transmit, to a base station, the one or more L3 measurement results.

63. The method of claim 59, wherein performing the SCell activation procedure based at least in part on the reporting of the one or more L3 measurement results for the SCell after receiving the indication to activate the SCell comprises:
skipping at least one of an L3 measurement, an L1 measurement, or an L1 measurement report of the SCell activation procedure based at least in part on reporting the one or more L3 measurement results for the SCell.

64. The method of claim 59, wherein performing the SCell activation procedure based at least in part on the reporting of the one or more L3 measurement results for the SCell after receiving the indication to activate the SCell comprises:
performing the SCell activation procedure according to an SCell activation delay associated with reporting of the one or more L3 measurement results for the SCell after receiving the indication to activate the SCell.

65. The method of claim 59, wherein the method is performed by a user equipment (UE) or one or more baseband processors.

66. A method, comprising:
transmitting an indication to activate a secondary cell (SCell);
after transmitting the indication to activate the SCell, receiving one or more L3 measurement results from the SCell; and
performing an SCell activation procedure based at least in part on the receipt of the one or more L3 measurement results for the SCell after transmitting the indication to activate the SCell.

67. The method of claim 66, wherein the SCell comprises an unknown SCell.

68. The method of claim 66, further comprising:
receiving one or more L3 measurement results for the SCell during the SCell activation procedure, the one or more L3 measurement having been performed before transmission of the indication to activate the SCell; and
in response to receiving the L3 measurement, transmitting a transmission configuration indication (TCI) state activation command.

69. The method of claim 66, wherein performing the SCell activation procedure based at least in part on the receipt of the one or more L3 measurement results for the SCell after transmitting the indication to activate the SCell comprises:
skipping at least one of an L3 measurement, an L1 measurement, or an L1 measurement report of the SCell activation procedure based at least in part on reporting the one or more L3 measurement results for the SCell.

70. The method of claim 66, wherein performing the SCell activation procedure based at least in part on the receipt of the one or more L3 measurement results for the SCell after transmitting the indication to activate the SCell comprises:
performing the SCell activation procedure according to an SCell activation delay associated with reporting of the one or more L3 measurement results for the SCell during SCell activation.

71. The method of claim 66, wherein the method is performed by a base station.
